(19) United States
(12) Patent Application Publication
(10) Pub. No.: US 2005/0083818 A1
(43) Pub. Date: Apr. 21, 2005

(54) Error measuring device for optical disk drive mechanism

(76) Inventors: Chi-Hsiang Wang, Hsinchu (TW); Shu-Ming Chang, Hsinchu (TW); Chih-Chung Wu, Hsinchu (TW)

Correspondence Address: BIRCH STEWART KOLASCH & BIRCH, PO BOX 747, FALLS CHURCH, VA, 22040-0747, US

(21) Appl. No.: 10/743,433

(22) Filed: Dec. 23, 2003

(30) Foreign Application Priority Data
Oct. 21, 2003 (TW) 92129189

(51) Int. Cl. G11B 7/00

(52) U.S. Cl. 369/53.28

(57) ABSTRACT

An error measuring device for optical disk drive mechanism is disclosed. The device is used to detect the assembly status of the spindle motor and the optical pickup head guide rods in an optical disk drive. A first sensor and a second sensor are installed on a referenced gauge to measure the turntable of the spindle motor and the plane formed by the optical pickup head guide rods. The plane characteristic parameters are thus obtained for rapid and precise calibration.

### BACKGROUND OF THE INVENTION

1. Field of Invention

The invention relates to a measuring device for optical disk drives and, in particular, to an optical disk drive assembly error measuring device that can measure assembly errors and rapidly and precisely calibrate the assembly status of optical disk drive elements in an automatic way.

2. Related Art

Due to recent advances in electronic information products, there are many related researches going on all over the world. With the progresses in semiconductor manufacturing technology, electronic products have more functions but cheaper prices than before. In particular, optical disk drives are widely accepted and used by the public because they can be used to save a huge mount of data. Recent development of the optical disk drives is in the direction of high capacities and high read/write (RW) speeds. For example, the next generation high-definition DVD (HD-DVD) features in using optical disks with high densities and having sizes that are more compact. As a result, the assembly errors that can be tolerated by such optical disks are very small. How to perform precision calibration after an optical disk drive is assembled is an important subject being studied by people in the field.

The calibration results have great consequences to the RW performance of an optical disk drive. For example, the assembly errors on mis-coplanarity of the two optical pickup head guide rods, which causes different tilts from the inner position to the outer position along the longitudinal direction of optical pickup head guide rods, and the relative tilt and height between the turntable of the spindle motor and the plane formed by the two optical pickup head guide rods, hereinafter called actuating plane, have to satisfy certain constraints.

A conventional method is to put a standard measurable tool, usually called the gauge, on the turntable and on actuating plane. By applying sensors to measure these gauges, one can obtain spatial information about the plane being measured. A device for measuring plane characteristics in the prior art is shown in FIGS. 1 and 2. The optical disk drive frame 1 provides the frame for installing other elements. The spindle motor 2 provides the driving force required for rotating the optical disk. Spindle motor turntable 5 supports the optical disk (not shown). Two optical pickup head guide rods 4 are installed on both sides to guide and support the optical pickup head 3. Only when the two guide rods are on the same plane will the optical pickup head have the same tilting angle at inner and outer positions along the longitudinal direction of guide rods. The first calibration module 6 adjusts the assembly position of the spindle motor 2. The second calibration module 7 adjusts the assembly position of one of the optical pickup head guide rods 4. The gauge 10 is placed on the spindle motor turntable 5 of the spindle motor 2. The gauge 8 and the gauge 9 are placed on the optical pickup head guide rods 4. Sensors 11, 12, and 13 along with a measuring arm 14 are installed above gauges 8, 9, and 10 correspondingly.

Sensors 11, 12, and 13 measure the gauges 8, 9, and 10 respectively to obtain the characteristics of the plane formed by them. They also obtain the assembly positions of the spindle motor turntable 5 and the optical pickup head guide rods 4. Control signals in accordance with the measured numerical values are transmitted to the first calibration module 6 and the second calibration module 7 respectively to execute corrections on the spindle motor 2 and the optical pickup head guide rods 4.

Although the measuring device mentioned above can operate in a reasonable way and achieves certain effects, it nevertheless has the following drawbacks:

(1) Properties between sensors differ from one to another because sensors are hardly manufactured 100% identical to each other via mass production. Since the device uses two sets of sensor to measure the difference between two planes, it may happen that even though the measured values are the same while the plane characteristics are actually different.

(2) Precise installation of these sensors is not easy. Since the sensors are installed on the measuring arm, their positions may be misaligned. Even if just one of them is off a little bit, measured values would drift drastically. Any non-cautious contact of sensors would lead the system to be calibrated again. Therefore, the device is inconvenient.

(3) Due to clearance or different placement of optical disk drive, the ideal plane to be calibrated is different from each optical disk drive as observing by sensors. Even if one spends a lot of efforts in calibrating the sensors, they may be in vain if the next optical disk drive is placed at a slightly different position.

All the above drawbacks are the problems yet to be solved.

### SUMMARY OF THE INVENTION

In view of the foregoing, the invention discloses an error measuring device for optical disk drive mechanism. It can perform rapid and accurate measurements for automatic calibration processes in assembly lines.

According to the error measuring device for optical disk drive mechanism disclosed herein, one referenced gauge is placed on one side of the optical pickup head guide rods. A spindle motor gauge is put on the turntable of spindle motor to form a first measuring plane, and a guide rod actuated gauge is placed on the other side of the referenced gauge to form a second measuring plane. A first sensor and a second sensor are installed on each side of the referenced gauge to measure the first and second planes, obtaining their characteristic parameters. The important technical feature of the invention is to install these two sensors on the referenced gauge placed on optical pickup head guide rods. Sensor positions relative to the referenced gauge are always fixed. Each time the referenced gauge stands on one side of the guide rods and measures the plane characteristics of the same optical disk drive mechanism where he stands. Therefore, the measured results will not change when going from one optical disk drive to the next one even if the disk drive locations are slightly different. Moreover, during the measuring process, the sensor positions are always fixed relative to the referenced plane, and the measured data from these gauge planes are directly representative to tilting angles and heights. One does not need to further compare data to make calibration as in the prior art. Consequently, the invention can avoid the characteristic difference of different sensors. In addition, the invention does not use a measuring arm to support these sensors, and there is no need to calibrate their relative positions. It is therefore simple and convenient, ideal for automatic measuring and calibrating processes.

### BRIEF DESCRIPTION OF THE DRAWINGS

The invention will become more fully understood from the detailed description given hereinbelow illustration only, and thus are not limitative of the present invention, and wherein:

FIG. 1 is a top view of the optical disk drive measuring device in the prior art;

FIG. 2 is a side view of the optical disk drive measuring device in the prior art;

FIG. 3 is a top view of the error measuring device for optical disk drive mechanism in the first embodiment of the invention;

FIG. 4 is a side view of the error measuring device for optical disk drive mechanism in the first embodiment of the invention;

FIG. 5 is a top view of the error measuring device for optical disk drive mechanism in the second embodiment of the invention;

FIG. 6 is a side view of the error measuring device for optical disk drive mechanism in the second embodiment of the invention;

FIG. 7 is a top view of the error measuring device for optical disk drive mechanism in the third embodiment of the invention; and

FIG. 8 is a side view of the error measuring device for optical disk drive mechanism in the third embodiment of the invention.

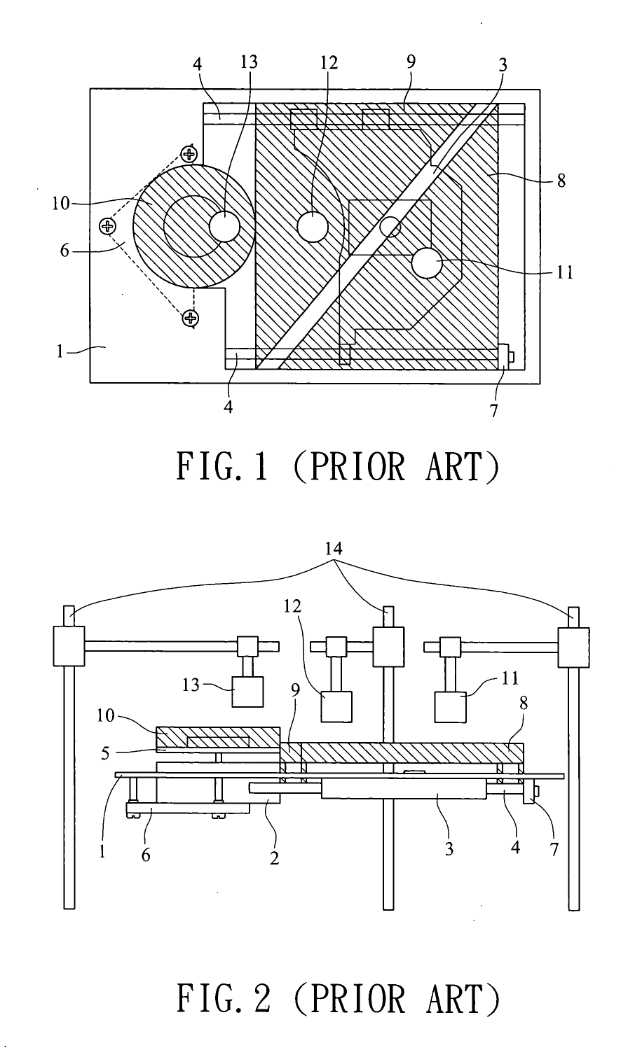

### DETAILED DESCRIPTION OF THE INVENTION

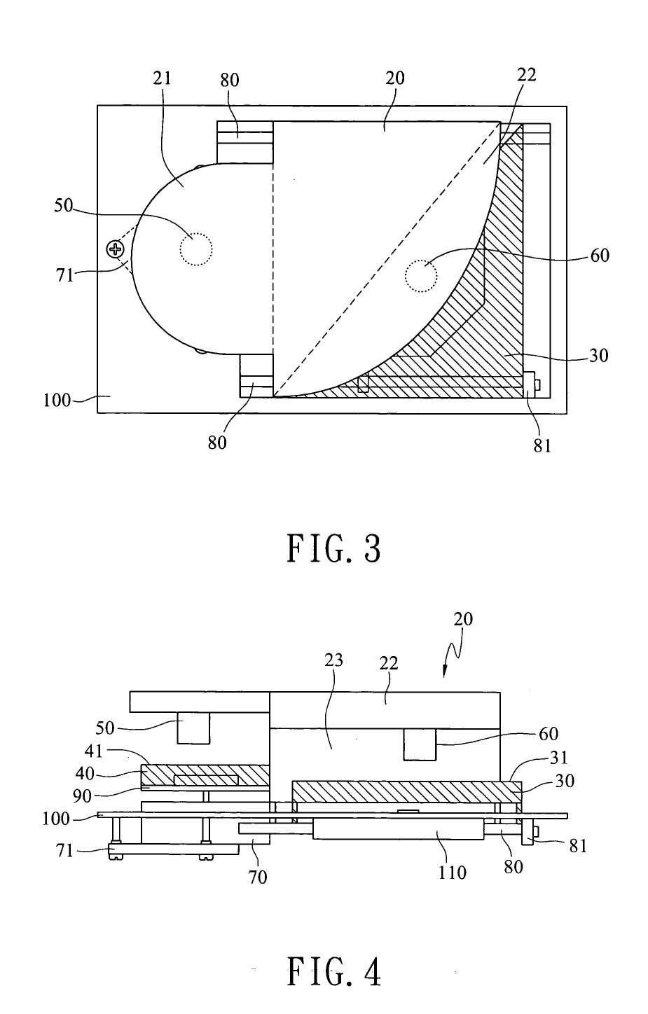

According to an error measuring device for optical disk drive mechanism disclosed by the invention, it can perform rapid and accurate measurements for automatic calibration processes in assembly lines. With reference to FIGS. 3 and 4, the invention includes a referenced gauge 20, a guide rod actuated gauge 30, a spindle motor gauge 40, at least one first sensor 50, and one second sensor 60. The optical disk drive comprises a frame 100, a spindle motor 70, optical pickup head guide rods 80, and an optical pickup head 110. The spindle motor 70 is used to rotate an optical disk (not shown). The optical pickup head guide rods 80 supports the optical pickup head 110 and guide them to correct positions on the optical disk. One can see from here that the requirement of the read/write (RW) precision of the optical disk drive increases with the increase of data density of the optical disk. As a result, the spindle motor turntable 90 on the spindle motor 70 and the installation of the optical pickup head guide rods 80 have to be precisely calibrated in order for the normal operations of the optical disk drive.

In particular, the optical pickup head guide rods 80 for taking the optical pickup head 110 to the correct RW positions and the position of the spindle motor turntable 90 have to be well calibrated, which is the primary goal of the invention. According to the disclosed error measuring device for optical disk drive mechanism, the referenced gauge 20 is installed on one side of the optical pickup head guide rods 80, more exactly the referenced gauge 20 just stands on the guide rods 80 freely by three contact points. The spindle motor gauge 40 is installed on top of the spindle motor turntable 90, forming a first measuring plane 41. The guide rod actuated gauge 30 is installed on the other side of the optical pickup head guide rods 80, forming a second measuring plane 31. The bottom of the referenced gauge 20 has a connecting part 23. Since any three points in space form a plane, the connecting part 23 has a triangular shape across the optical pickup head guide rods 80. In other words, the referenced gauge 20 and the guide rod actuated gauge 30 are symmetric on opposite sides of the optical pickup head guide rods 80, which defines the coplanarity of the optical pickup head guide rods 80. Since the optical pickup head guide rods 80 may be skewed relative to each other, we have to use the referenced gauge 20 and the guide rod actuated gauge 30 to help defining the coplanarity of the optical pickup head guide rods 80. The measuring and calibrating details are to be explained later.

Along the longitudinal direction of optical pickup head guide rods 80 and toward the spindle motor 70, a first wedge-shape measuring part 21 protrudes from the referenced gauge 20. The first sensor 50 is installed at the bottom of the first measuring part 21. Along opposite direction toward the guide rod actuated gauge 30, a second wedge-shape measuring part 22 protrudes from the referenced gauge 20. Likewise, a second sensor 60 is installed at the bottom of the second measuring part 22.

In the following, we describe the details of the measuring process. First, we measure a golden sample of optical disk drive that all assembly errors have been calibrated. The two sensor 50, and 60 measure the second plane 31 of the guide rod actuated gauge 30 and the first plane 41 of the spindle motor gauge 40. The characteristic parameters of these two planes, such as the tilting angles and heights from the sensors, are recorded as control target values in physical memory or used to calibrate the sensors.

Afterwards, one takes another optical disk drive to be calibrated. The second sensor 60 measures the second plane 31 of the guide rod actuated gauge 30. By comparing to the previously recorded plane characteristic parameters from the golden sample, one can obtain the differences in the tilting angle and height. Feedback control signals are then generated and sent to the second calibration module 81 to perform adjustments to the optical pickup head guide rods 80.

Likewise, the first sensor 50 measures the first plane 41 of the spindle motor gauge 40. The measured plane characteristic parameters of this optical disk drive are compared to the golden sample to obtain feedback control signals for adjustments. These control signals are sent to the first calibration module 71 to adjust the position of spindle motor 70.

The above measurements can make corrections on many optical disk drives. Therefore, one can use it to perform automatic measurements and calibrations in assembly lines.

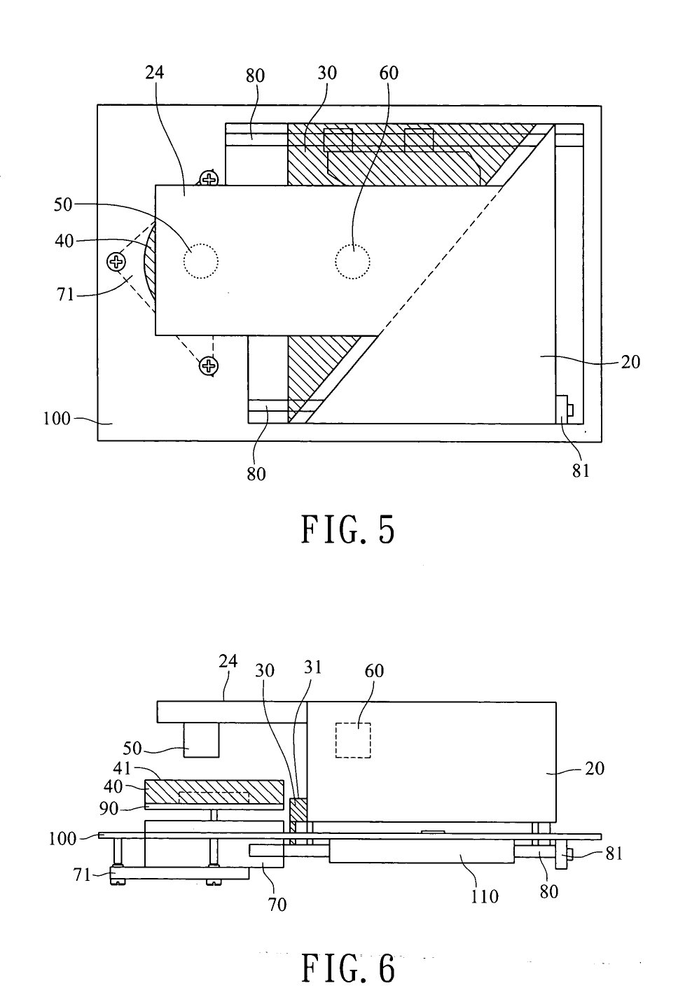

In fact, there are many measuring methods. FIGS. 5 and 6 show a second embodiment of the invention. It contains a referenced gauge 20, a guide rod actuated gauge 30, a spindle motor gauge 40. The spindle motor gauge 40 is installed on the spindle motor turntable 90. The referenced gauge 20 and the guide rod actuated gauge 30 stand freely and adjacent to each other on optical pickup head guide rods 80 by three contact points in a symmetric way, thereby defining the coplanarity of these two optical pickup head guide rods 80 in space. A first measuring plane 41 is formed on the top of the spindle motor gauge 40. A second measuring plane 31 is formed on the top of the guide rod actuated gauge 30. A measuring arm 24 extends from one side of the referenced gauge 20. Corresponding to the first plane 41, a first sensor 50 is installed on the measuring arm 24. Corresponding to the second plane 31, a second sensor 60 is installed on the measuring arm 24.

To perform measurements, as in the previous embodiment, one first measures a golden sample of optical disk drive that all assembly errors have been calibrated. The first sensors 50, and the second 60 measure the second plane 31 of the guide rod actuated gauge 30 and the first plane 41 of the spindle motor gauge 40. The characteristic parameters of these two planes, such as the tilting angles and heights from the sensors, are recorded as control target values in physical memory or used to calibrate the sensors.

Afterwards, one puts on another optical disk drive to be calibrated. The second sensor 60 measures the second plane 31 of the guide rod actuated gauge 30. By comparing to the previously recorded plane characteristic parameters from the golden sample, one can obtain the differences in the tilting angle and height. Feedback control signals are then generated and sent to the second calibration module 81 to perform adjustments to the optical pickup head guide rods 80.

Likewise, the first sensor 50 measures the first plane 41 of the spindle motor gauge 40. The measured plane characteristic parameters of this optical disk drive are compared to the golden sample to obtain a feedback control signals for adjustments. These control signals are sent to the first calibration module 71 to adjust the spindle motor 70.

The second embodiment is similar to the first embodiment. The only difference is in the positions of the referenced gauge 20 and the guide rod actuated gauge 30.

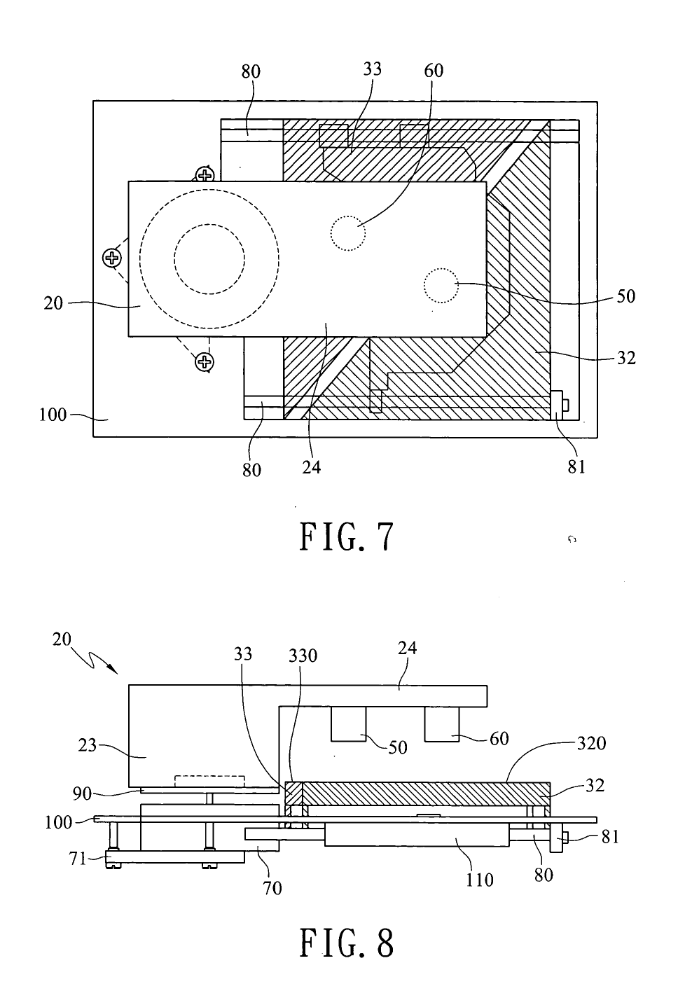

The placement position of the referenced gauge 20 is not limited to the optical pickup head guide rod 80. It can be put on the spindle motor turntable 90 too. We show a third embodiment in FIGS. 7 and 8. It contains a referenced gauge 20, a first guide rod actuated gauge 32, and a second guide rod actuated gauge 33. The difference between the third embodiment and the previous two is that the referenced gauge 20 is installed on the spindle motor turntable 90. The first guide rod actuated gauge 32 and the second guide rod actuated gauge 33 stand freely and adjacent to each other on top of optical pickup head guide rods 80 by three contact points, thereby defining the coplanarity of these two optical pickup head guide rods 80 in space. A first gauge plane 320 is formed on top of the first guide rod actuated gauge 32. A second gauge plane 330 is formed on top of the second guide rod actuated gauge 33. A measuring arm 24 extends from one side of the referenced gauge 20. Corresponding to the first gauge plane 320, a first sensor 50 is installed on the measuring arm 24. Corresponding to the second gauge plane 330, a second sensor 60 is installed on the measuring arm 24.

To perform measurements, one first measures a golden sample of optical disk drive that all assembly errors have been calibrated. These two sensors 50, and 60 measure the first gauge plane 320 of the first guide rod actuated gauge 32 and the second gauge plane 330 of the second guide rod actuated gauge 33. The characteristic parameters of the two planes, such as the tilting angles and heights from the sensors, are recorded as control target values in physical memory or used to calibrate the sensors.

Afterwards, one puts on another optical disk drive to be calibrated. The first sensor 50 measures the first gauge plane 320 of the first guide rod actuated gauge 32. The second sensor 60 measures the second gauge plane 330 of the second guide rod actuated gauge 33. These results are compared to the previously recorded plane characteristic parameters from the golden sample, obtaining the differences in the tilting angle and height. A set of feedback control signals are then generated and sent to the first and second calibration modules 71, 81 to perform adjustments to the spindle motor 70 and the optical pickup head guide rods 80. These two optical pickup head guide rods 80 are adjusted to be in the same plane, to which the spindle motor turntable 90 is parallel. The measurements and calibrations are completed within the gauged height ranges.

From the above description, one easily sees that the disclosed error measuring device for optical disk drive mechanism has the following advantages:

(1) It provides a convenient measuring method. According to the invention, all sensors are installed on the same referenced gauge 20. Their relative positions are always fixed. Therefore, the results will not change as the position of the optical disk drive to be measured varies.

(2) It provides accurate measuring results. Since the sensors are installed at fixed positions and have a referenced plane, the data measured from the gauge planes directly represent the accurate tilting angles and heights. One does not need to compare data to make corrections as in the prior art. Therefore, it can prevent the errors from the different intrinsic properties of the sensors.

(3) It reduces the cost. The prior art requires the use of many measuring arms and sensors. The invention needs fewer elements and has a simpler structure. One does not need to calibrate the sensors each time. Therefore, the cost is greatly reduced, ideal for enhancing the competitive power of business.

Certain variations would be apparent to those skilled in the art, which variations are considered within the spirit and scope of the claimed invention.

1. An error measuring device for optical disk drive mechanism to detect the assembly status of a spindle motor and two optical pickup head guide rods of an optical disk drive, the error measuring device comprising:
a spindle motor gauge, which is installed on top of the spindle motor to form a first measuring plane;
two gauges, including a referenced gauge and a guide rod actuated gauge, which stand freely on one side of the optical pickup head guide rods in a symmetric way, the guide rod actuated gauge forming a second measuring plane;
at least one first sensor, which is installed on the side of the referenced gauge corresponding to the first plane to measure the characteristic parameters of the first plane; and
at least one second sensor, which is installed on the side of the referenced gauge corresponding to the second plane to measure characteristic parameters of the second plane.

2. The error measuring device of claim 1 further comprising a first calibration module, which receives feedback control signals from the first sensor to adjust the assembly status of the spindle motor.

3. The error measuring device of claim 1 further comprising a second calibration module, which receives feedback control signals from the second sensor to adjust the assembly status of the optical pickup head guide rods.

4. The error measuring device of claim 1, wherein the characteristic parameters of the first plane includes a tilting angle.

5. The error measuring device of claim 1, wherein the characteristic parameters of the first plane includes a height.

6. The error measuring device of claim 1, wherein the characteristic parameters of the second plane includes a tilting angle.

7. The error measuring device of claim 1, wherein the characteristic parameters of the second plane includes a height.

8. The error measuring device of claim 1, wherein a first measuring part protrudes from the side of the referenced gauge toward the spindle motor for installing the first sensor.

9. The error measuring device of claim 1, wherein a second measuring part protrudes from the side of the referenced gauge toward the guide rod actuated gauge for installing the second sensor.

10. The error measuring device of claim 1, wherein the referenced gauge stands freely on the optical pickup head guide rods by three contact points.

11. The error measuring device of claim 1, wherein the guide rod actuated gauge is installed on the optical pickup head guide rods by three contact points.

12. An error measuring device for optical disk drive assembly to detect the assembly status of a spindle motor and two optical pickup head guide rods of an optical disk drive, the error measuring device comprising:
a referenced gauge, which is installed on top of the spindle motor;
two gauges, including a first guide rod actuated gauge and a second guide rod actuated gauge, which stand freely on one side of the optical pickup head guide rods in a symmetric way, the first guide rod actuated gauge forming a first gauge plane and the second guide rod actuated gauge forming a second gauge plane;
at least one first sensor, which is installed on the side of the referenced gauge corresponding to the first gauge plane to measure the characteristic parameters of the first gauge plane; and
at least one second sensor, which are installed on the side of the referenced gauge corresponding to the second gauge plane to measure characteristic parameters of the second gauge plane.

13. The error measuring device of claim 12 further comprising a first calibration module, which receives feedback control signals from the first sensor to adjust the assembly status of the spindle motor.

14. The error measuring device of claim 12 further comprising a second calibration module, which receives feedback control signals from the second sensor to adjust the assembly status of the optical pickup head guide rods.

15. The error measuring device of claim 12, wherein the characteristic parameters of the first plane includes a tilting angle.

16. The error measuring device of claim 12, wherein the characteristic parameters of the first plane includes a height.

17. The error measuring device of claim 12, wherein the characteristic parameters of the second plane includes a tilting angle.

18. The error measuring device of claim 12, wherein the characteristic parameters of the second plane includes a height.

19. The error measuring device of claim 12, wherein a measuring arm protrudes from the referenced gauge toward the optical pickup head guide rods for installing the first sensor and the second sensor.

20. The error measuring device of claim 12, wherein each of the first guide rod actuated gauge and the second guide rod actuated gauge is installed on the optical pickup head guide rods by three contact points.
